(19) United States
(12) Patent Application Publication
(10) Pub. No.: US 2014/0244904 A1
(43) Pub. Date: Aug. 28, 2014

(54) MEMORY DEVICE AND COMPUTER SYSTEM

(71) Applicant: Kabushiki Kaisha Toshiba, Minato-ku (JP)

(72) Inventors: Nobuhiro KONDO, Kanagawa (JP); Atsushi Kunimatsu, Chiba (JP); Atsushi Shiraishi, Kanagawa (JP)

(73) Assignee: Kabushiki Kaisha Toshiba, Minato-ku (JP)

(21) Appl. No.: 13/957,771

(22) Filed: Aug. 2, 2013

Related U.S. Application Data
(60) Provisional application No. 61/770,805, filed on Feb. 28, 2013.

(51) Int. Cl. G06F 12/02

(52) U.S. Cl. CPC G06F 12/0246
USPC 711/103

(57) ABSTRACT

A memory device according to an embodiment includes a non-volatile storage device from which data is read and to which data is written, an interface that is connected to the host device by a multiple upstream lanes and/or a multiple downstream lanes and performs data communication in both directions with the host device, and a memory controller. The memory controller changes a connection state of each lane on the basis of lane settings which are determined on the basis of at least one of an amount of data transmitted and the sequentiality of data when the data is transmitted between the memory device and the host device.

### CROSS-REFERENCE TO RELATED APPLICATIONS

This application is based upon and claims the benefit of priority from U.S. Provisional Application No. 61/770,805), filed on Feb. 28, 2013; the entire contents of which are incorporated herein by reference.

### FIELD

Embodiments described herein relate generally to a memory device and a computer system.

### BACKGROUND

A mipi UniPro 1.41.00 rev.6, mipi M-PHY 2.0 standard adopts a method of using a multiple lanes, which are communication path, in order to increase a data communication rate. However, even when the standard is applied to a flash storage device, such as a UFS (Universal Flash Storage) device, high-speed data communication is needed only in predetermined processes, such as a process of reading sequential data. When high-speed data communication is not needed, current consumption increases due to the use of a multiple lanes. Therefore, it is preferable to achieve high-speed data communication and reduce current consumption.

### BRIEF DESCRIPTION OF THE DRAWINGS

FIG. 1 is a diagram illustrating the structure of a computer system according to a first embodiment;

FIG. 2 is a diagram illustrating the connection structure of M-PHY;

FIG. 3A is a diagram illustrating the functional structure of the computer system when the connection state of lanes is changed in response to instructions from a memory device;

FIG. 3B is a diagram illustrating the functional structure of the computer system when the connection state of the lanes is changed in response to instructions from a host;

FIG. 4 is a diagram illustrating an example of a communication process when data is written between the host and the memory device;

FIG. 5 is a diagram illustrating an example of a power state set to each lane;

FIG. 6 is a diagram illustrating an example of a change in the mode of the lane;

FIG. 7 is a flowchart illustrating the procedure of a mode change process (Example 1-1) when the mode is changed on the basis of the determination of the memory device and is changed to an initial mode after data communication is completed in the changed mode;

FIG. 8 is a flowchart illustrating the procedure of a mode change process (Example 1-2) when the mode is changed on the basis of the determination of the memory device and it is checked whether the mode is an initial mode after data communication is completed;

FIG. 9 is a flowchart illustrating the procedure of a mode change process (Example 2-1) when the mode is changed on the basis of the determination of the host and is changed to the initial mode after data communication is completed in the changed mode;

FIG. 10 is a flowchart illustrating the procedure of a mode change process (Example 2-2) when the mode is changed on the basis of the determination of the host and it is checked whether the mode is the initial mode after data communication is completed;

FIG. 11 is a flowchart illustrating the procedure of a mode change process (Example 1-3) when the mode is changed during communication on the basis of the determination of the memory device and is changed to the initial mode after data communication is completed in the changed mode;

FIG. 12 is a flowchart illustrating the procedure of a mode change process (Example 1-4) when the mode is changed during communication on the basis of the determination of the memory device and it is checked whether the mode is the initial mode after data communication is completed;

FIG. 13 is a flowchart illustrating the procedure of a mode change process (Example 2-3) when the mode is changed during communication on the basis of the determination of the host and is changed to the initial mode after data communication is completed in the changed mode;

FIG. 14 is a flowchart illustrating the procedure of a mode change process (Example 2-4) when the mode is changed during communication on the basis of the determination of the host and it is checked whether the mode is the initial mode after data communication is completed;

FIG. 15A is a diagram illustrating the structure of the computer system when the host and the memory device are connected to each other by four upstream lanes and four downstream lanes; and

FIG. 15B is a diagram illustrating the structure of the computer system when the numbers of upstream lanes and downstream lanes of the host and the memory device are asymmetric.

### DETAILED DESCRIPTION

According to an embodiment, a memory device is provided. The memory device includes a non-volatile storage device from which data is read and to which data is written in response to a request from a host device. In addition, the memory device includes an interface that is connected to the host device by a multiple upstream lanes and/or a multiple downstream lanes and performs data communication in both directions with the host device. Furthermore, the memory device includes a memory controller that controls the non-volatile storage device and the interface. The memory controller includes a lane change unit that changes a connection state of each lane on the basis of lane settings which are used for communication with the host device. The lane settings are determined on the basis of at least one of an amount of data transmitted and a sequentiality of data when the data is transmitted between the memory device and the host device.

Hereinafter, memory devices and computer systems according to embodiments of the invention will be described in detail with reference to the accompanying drawings. The invention is not limited by the embodiments.

### First Embodiment

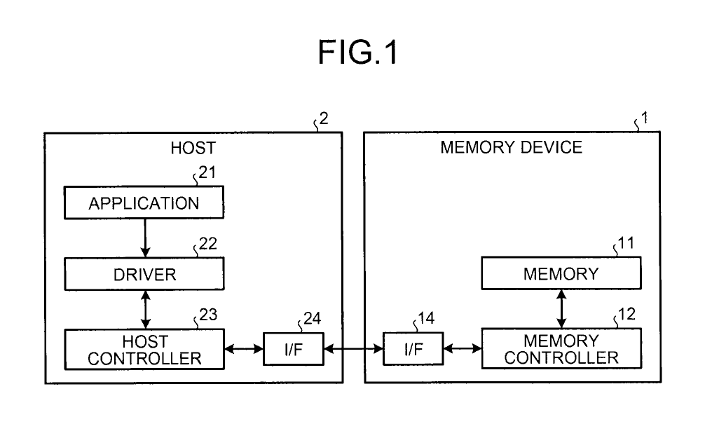

FIG. 1 is a diagram illustrating the structure of a computer system according to a first embodiment. FIG. 1 illustrates the hardware structure of the computer system. The computer system performs data communication on the basis of a client-server model and is, for example, a mobile phone, a smart phone, a tablet terminal, or a mobile device.

In the computer system, a physical layer (layer 1) for data communication is controlled. The computer system is applied to communication using, for example, a mipi UniPro standard or a mipi M-PHY standard which is used as a UFS standard. The UFS standard is a Flash storage standard used in JEDEC. The computer system has a high-speed serial interface including a multiple lanes as data transmission paths.

The computer system includes a memory device 1 and a host 2. The memory device 1 and the host 2 are connected to each other by a multiple lanes. In the computer system according to this embodiment, the memory device and the host are connected to each other by one upstream lane and one downstream lane in the normal mode. When high-speed communication is needed, for example, when data is sequentially read, the memory device and the host are connected to each other by two or more upstream lanes and/or two or more downstream lanes.

The memory device 1 is, for example, a semiconductor storage device in which the writing and reading speeds are asymmetric. The memory device 1 is configured so as to communicate with the host 2. The memory device 1 and the host 2 communicate with each other in such a way that the memory device 1 can designate at least the size and position of write data in response to a write request from the host 2.

The memory device 1 operates as a target and the host 2 operates as an initiator. For example, the memory device 1 is a UFS (Universal Flash Storage) memory device and the host 2 is a UFS host which supports the UFS memory device.

The memory device 1 includes at least a memory 11, which is a non-volatile storage device (for example, a non-volatile semiconductor memory), a memory controller 12 for controlling the memory 11, and an I/F (interface) 14.

The memory 11 writes and reads data in a specific unit of writing including a plurality of bits. In addition, the memory 11 erases data in unit of erase including a plurality of write units.

For example, the memory 11 includes one or a plurality of NAND flash memories. When the memory 11 is a NAND flash memory, the memory 11 writes and reads data in, for example, unit of page. In addition, when the memory 11 is a NAND flash memory, it erases data in a block unit. Each block includes a plurality of pages having consecutive physical addresses. The memory 11 is not necessarily limited to the NAND flash memory. The memory 11 may be, for example, an FERAM or an MRAM.

The memory controller 12 controls the memory 11 and the I/F 14. The memory controller 12 is arranged between the memory 11 and the I/F 14. The memory controller 12 communicates with a host controller 23 and performs, for example, a process of interpreting commands based on the UFS standard and a process of reading and writing data from and to the memory 11. The memory controller 12 writes data to the memory 11 or reads data from the memory 11, in response to requests from the host 2.

The I/F 14 is a host interface which is connected to an I/F 24 of the host 2. The I/F 14 performs a process required for communication between the memory device 1 and the host 2. Specifically, the I/F 14 performs communication between the memory device 1 and the host 2 according to a communication protocol used in both the memory device 1 and the host 2. When the memory device 1 is a UFS memory device, the I/F 14 is, for example, a UFS interface. In the UFS interface, a physical layer is based on the MIPI M-PHY standard and a link layer is based on the MIPI UniPro standard.

The I/F 14 is connected to a buffer (not illustrated). The buffer receives data which is transmitted from the host 2 to the memory device 1 through the I/F 14 and temporarily stores the received data. In addition, the buffer temporarily stores data to be transmitted from the memory device 1 to the host 2 (I/F 24).

The memory device 1 may be, for example, an embedded type which is mounted on a printed circuit board by solder or a removable type which is removable from a card slot of the host 2. The host 2 includes at least an application 21, a driver 22, the host controller 23, and the I/F 24.

The application 21 is a program for providing various functions to an end user. The application 21 operates on, for example, a system which is called an OS and records data used by the program to the memory device 1 or reads data from the memory device 1. In general, the application 21 accesses the memory device 1 using an interface prepared by a program which is called a driver on the OS.

The driver 22 is a program which operates on the OS and provides a function of controlling hardware of the system to the application 21 (program).

When the driver 22 is a UFS driver, it provides a function which can control the functions of a storage, such as the writing and reading of data, using an interface defined by a generally used SCSI standard. The driver 22 interprets a control command which is input from the interface provided by the application 21 using a driver program and controls the host controller 23 according to the procedure defined by, for example, the UFS standard. In this way, the UFS memory device (memory device 1) connected to the host controller 23 is appropriately controlled.

The host controller 23 is controlled by the driver 22 and controls the I/F 24. The host controller 23 is defined by, for example, the UFS standard. The host controller 23 sets various registers to communicate with the UFS memory device connected by the I/F 24 and can perform, for example, a process of setting the communication rate and a process of reading and writing data.

The I/F 24 is a memory interface which is connected to the I/F 14 of the memory device. The I/F 24 performs a process required for communication between the memory device 1 and the host 2. Specifically, the I/F 24 performs communication between the memory device 1 and the host 2 according to the communication protocol used in both the memory device 1 and the host 2. When the memory device 1 is a UFS memory device, the I/F 24 is, for example, a UFS interface. In the UFS interface, a physical layer is based on the MIPI M-PHY standard and a link layer is based on the MIPI UniPro standard.

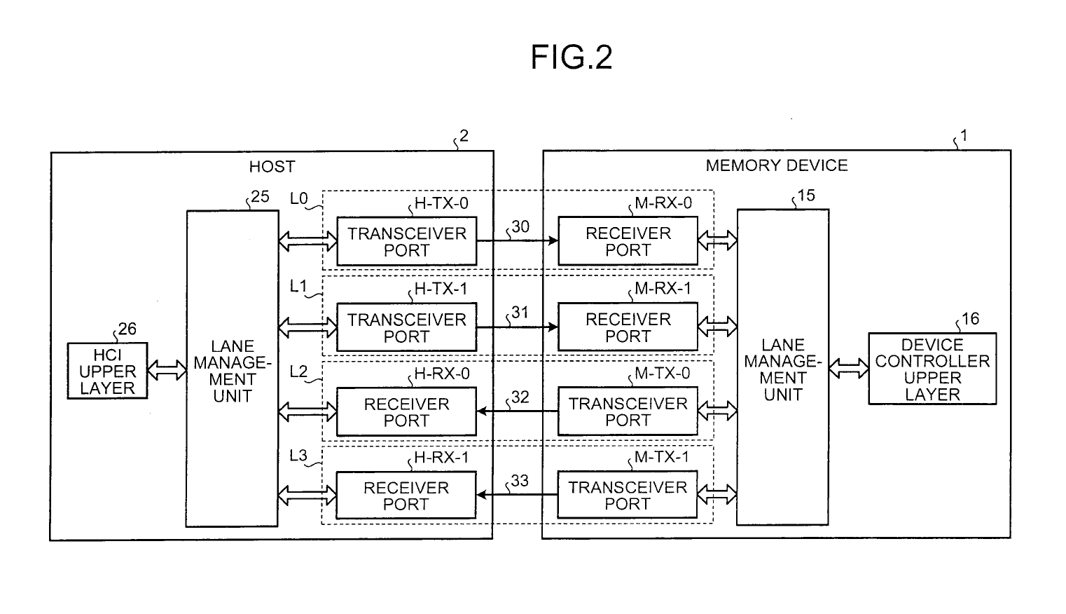

FIG. 2 is a diagram illustrating the connection structure of M-PHY. FIG. 2 illustrates the connection structure of M-PHY when the memory device 1 and the host 2 are connected to each other by two upstream lanes and two downstream lanes. The memory device 1 and the host 2 are connected to each other by a full-duplex system and different lines (lanes) are used in upstream communication and downstream communication.

The host 2 includes transceiver ports H-TX-0 and H-TX-1, receiver ports H-RX-0 and H-RX-1, a lane management unit 25, and an HCI (host controller interface) upper layer 26.

The transceiver ports H-TX-0 and H-TX-1 and the receiver ports H-RX-0 and H-RX-1 are used to connect the host 2 so as to communicate with the memory device 1 and correspond to, for example, the I/F 24.

The memory device 1 includes receiver ports M-RX-0 and M-RX-1, transceiver ports M-TX-0 and M-TX-1, a lane management unit 15, and a device controller upper layer 16.

The receiver ports M-RX-0 and M-RX-1 and the transceiver ports M-TX-0 and M-TX-1 are used to connect the memory device 1 so as to communicate with the host 2 and correspond to, for example, the I/F 14.

The transceiver ports H-TX-0 and H-TX-1 are used to transmit data from the host 2 to the memory device 1. The receiver ports M-RX-0 and M-RX-1 are used to receive data transmitted from the host 2 to the memory device 1.

The transceiver ports M-TX-0 and M-TX-1 are used to transmit data from the memory device 1 to the host 2. The receiver ports H-RX-0 and H-RX-1 are used to receive data transmitted from the memory device 1 to the host 2.

The transceiver port H-TX-0 and the receiver port M-RX-0 are connected to each other by a line 30. A first downstream lane formed by the transceiver port H-TX-0, the receiver port M-RX-0, and the line 30 is a lane L0.

The transceiver port H-TX-1 and the receiver port M-RX-1 are connected to each other by a line 31. A second downstream lane formed by the transceiver port H-TX-1, the receiver port M-RX-1, and the line 31 is a lane L1.

The transceiver port M-TX-0 and the receiver port H-RX-0 are connected to each other by a line 32. A first upstream lane formed by the transceiver port M-TX-0, the receiver port H-RX-0, and the line 32 is a lane L2.

The transceiver port M-TX-1 and the receiver port H-RX-1 are connected to each other by a line 33. A second upstream lane formed by the transceiver port M-TX-1, the receiver port H-RX-1, and the line 33 is a lane L3.

Each of the lines 30 to 33 includes, for example, two connection lines (PIN). In addition, in this embodiment, each of the lanes L0 to L3 can be switched between connection and disconnection under the control of the memory device 1 and the host 2.

In the computer system illustrated in FIG. 2, four lanes L0 to L3 form a sub link, and the sub link and the lane management units 15 and 25 form a link.

When changing the connection state of the lanes L0 to L3, the lane management unit 25 controls the transceiver ports H-TX-0 and H-TX-1 and the receiver ports H-RX-0 and H-RX-1. In this embodiment, the lane management unit 25 changes the connection state of the lanes L0 to L3 depending on at least one of the amount of data transmitted and the sequentiality of data. When sequential data with a size of, for example, 32 KB or more is transmitted, the lane management unit 25 increases the number of connections of the lanes L0 to L3.

The lane management unit 25 may be arranged in the driver 22 or the host controller 23, or it may be provided separately from the driver 22 and the host controller 23. The HCI upper layer 26 is a layer higher than the layer treated by the lane management unit 25.

When changing the connection state of the lanes L0 to L3, the lane management unit 15 controls the transceiver ports M-TX-0 and M-TX-1 and the receiver ports M-RX-0 and M-RX-1. In this embodiment, the lane management unit 15 changes the connection state of the lanes L0 to L3 depending on at least one of the amount of data transmitted and the sequentiality of data. The device controller upper layer 16 is a layer higher than the layer which is treated by the lane management unit 15.

As such, in the computer system, the lanes (in this embodiment, the lanes L0 and L1) which can be set to upstream communication and the lanes (in this embodiment, the lanes L2 and L3) which can be set to downstream communication are predetermined. In the computer system, since different lanes are used in the upstream communication and the downstream communication, it is possible to perform the upstream communication and the downstream communication at the same time. In addition, in the computer system, even when the connection state is changed for the upstream communication, the downstream communication is not affected by the change in the connection state. Similarly, in the computer system, even when the connection state is changed for the downstream communication, the upstream communication is not affected by the change in the connection state.

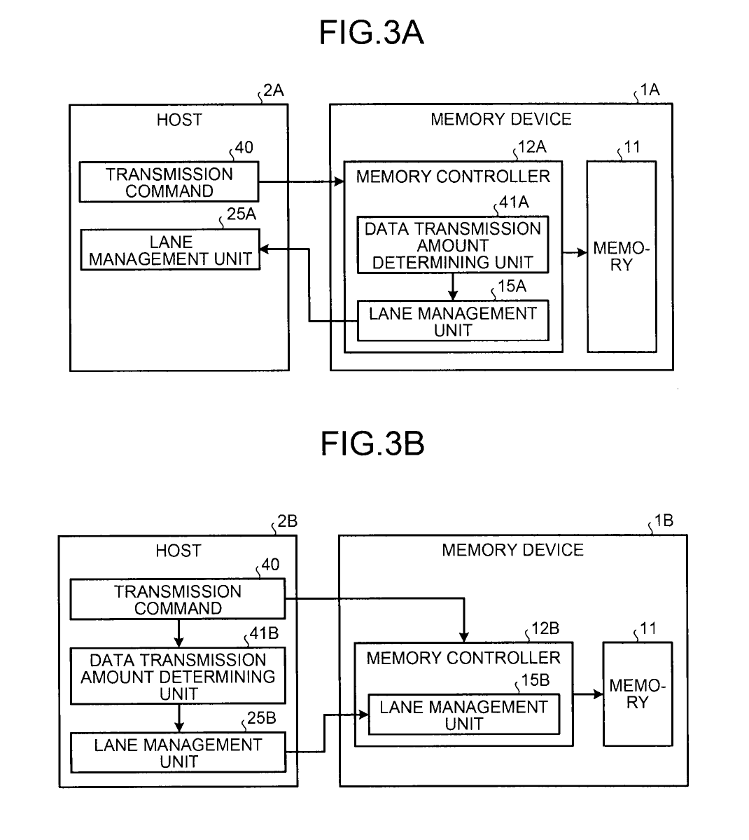

The computer system may change the connection state of the lanes L0 to L3 in response to instructions from the memory device 1 or instruction from the host 2. FIG. 3A is a diagram illustrating the functional structure of the computer system when the connection state of the lanes is changed in response to the instructions from the memory device. Here, the functional structure of a memory device 1A, which is an example of the memory device 1, and the functional structure of a host 2A, which is an example of the host 2, will be described.

When the connection state of the lanes is changed in response to the instructions from the memory device, the memory device 1A and the host 2A are used as the computer system. The memory device 1A includes a memory controller 12A which is an example of the memory controller 12. The memory controller 12A includes a data transmission amount determining unit 41A and a lane management unit 15A which is an example of the lane management unit 15. The host 2A includes a lane management unit 25A which is an example of the lane management unit 25. In FIG. 3A, the I/F 14 and the I/F 24 are not illustrated.

The data transmission amount determining unit 41A determines whether high-speed data transmission is needed between the host 2A and the memory device 1A. This determination is performed on the basis of, for example, the amount of data transmitted or the sequentiality of data which is indicated by a transmission command 40 transmitted from the host 2A, the amount of data transmitted which is indicated by a transmission request transmitted from the memory device 1A to the host 2A when the transmission command 40 is a write command, and information about the amount of data transmitted or the sequentiality of data required for the process of the application 21, which is transmitted from the application 21 to the memory device 1A.

When the transmission command 40 is received, the data transmission amount determining unit 41A determines whether high-speed data transmission is needed on the basis of the transmission command 40. When the transmission request is transmitted from the memory device 1A to the host 2A, the data transmission amount determining unit 41A determines whether high-speed data transmission is needed on the basis of the transmission request. When the information transmitted from the application 21 is received, the data transmission amount determining unit 41A determines whether high-speed data transmission is needed on the basis of the information transmitted from the application 21.

The data transmission amount determining unit 41A determines one of the lanes L0 to L3 which is to be set to a connected state (lane settings) on the basis of the determination result. The data transmission amount determining unit 41A transmits the determined lane settings to the lane management unit 15A.

The transmission command 40 is a command to write data to the memory device 1A or a command to read data from the memory device 1A. The transmission command 40 includes information indicating the amount of data transmitted (the amount of data read or the amount of data written) and the memory device 1A can determine the sequentiality of data transmitted.

The lane management unit 15A changes the connection state of the lanes L0 to L3 in the memory device 1A on the basis of the lane settings transmitted from the data transmission amount determining unit 41A. Specifically, the lane management unit 15A turns on or off the connection state by the receiver ports M-RX-0 and M-RX-1 and the connection state by the transceiver ports M-TX-0 and M-TX-1 on the basis of the lane settings.

The lane management unit 25A changes the connection state of the lanes L0 to L3 in the host 2A on the basis of the lane settings transmitted from the lane management unit 15A. Specifically, the lane management unit 25A turns on or off the connection state by the transceiver ports H-TX-0 and H-TX-1 and the connection state by the receiver ports H-RX-0 and H-RX-1 on the basis of the lane settings.

The data transmission amount determining unit 41A increases the number of lanes set to the connected state as the amount of data transmitted increases. For example, when the amount of data transmitted is greater than a predetermined value, the data transmission amount determining unit 41A sets the lanes L0 to L3 to the connected state. On the other hand, when the amount of data transmitted is less than the predetermined value, the data transmission amount determining unit 41A sets the lanes L0 and L2 to the connected state and sets the lanes L1 and L3 to a disconnected state.

The data transmission amount determining unit 41A increases the number of lanes set to the connected state as the sequentiality of data increases. For example, when the sequentiality of data is greater than a predetermined value, the data transmission amount determining unit 41A sets the lanes L0 to L3 to the connected state. On the other hand, when the sequentiality of data is less than the predetermined value (a small amount of data is transmitted), the data transmission amount determining unit 41A sets the lanes L0 and L2 to the connected state and sets the lanes L1 and L3 to the disconnected state.

The data transmission amount determining unit 41A determines the sequentiality of data on the basis of, for example, the total amount of data transmitted which is included in one data transmission command. In addition, in a flash storage, since data transmission commands, such as Sequential Read/Write and Random Read/Write, are used, the data transmission amount determining unit 41A may determine whether there is sequential data on the basis of the type of data transmission commands.

For example, when the amount of data transmitted which is included in one data transmission command is less than a predetermined value (for example, 32 KB, 64 KB, or 128 KB), the data transmission amount determining unit 41A determines that the sequentiality of data is less than a predetermined value.

For example, when the amount of data transmitted which is included in one data transmission command is greater than the predetermined value, the data transmission amount determining unit 41A determines that the sequentiality of data is greater than a predetermined value.

FIG. 3B is a diagram illustrating the functional structure of the computer system when the connection state of the lanes is changed in response to the instructions from the host. Here, the functional structure of a memory device 1B, which is an example of the memory device 1, and the functional structure of a host 2B, which is an example of the host 2, will be described.

When the connection state of the lanes is changed in response to the instructions from the host device, the memory device 1B and the host 2B are used as the computer system. The memory device 1B includes a memory controller 12B which is an example of the memory controller 12. The memory controller 12B includes a lane management unit 15B which is an example of the lane management unit 15. The host 2B includes a data transmission amount determining unit 41B and a lane management unit 25B which is an example of the lane management unit 25. In FIG. 3B, the I/F 14 and the I/F 24 are not illustrated.

The data transmission amount determining unit 41B determines whether high-speed data transmission is needed between the memory device 1B and the host 2B. A determination method is performed on the basis of, for example, the amount of data transmitted and the sequentiality of data included in the transmission command 40, similarly to the determination method used by the data transmission amount determining unit 41A. In addition, the determination timing is the same as that in the data transmission amount determining unit 41A.

The data transmission amount determining unit 41B determines one of the lanes L0 to L3 which is to be set to the connected state (lane settings), on the basis of the determination result. The data transmission amount determining unit 41B transmits the determined lane settings to the lane management unit 25B.

The lane management unit 25B changes the connection state of the lanes L0 to L3 in the host 2B on the basis of the lane settings transmitted from the data transmission amount determining unit 41B. Specifically, the lane management unit 25B turns on or off the connection state by the transceiver ports H-TX-0 and H-TX-1 and the connection state by the receiver ports H-RX-0 and H-RX-1, on the basis of the lane settings.

The lane management unit 15B changes the connection state of the lanes L0 to L3 in the memory device 1B on the basis of the lane settings transmitted from the lane management unit 25B. Specifically, the lane management unit 15B turns on or off the connection state by the receiver ports M-RX-0 and M-RX-1 and the connection state by the transceiver ports M-TX-0 and M-TX-1, on the basis of the lane settings.

The data transmission amount determining unit 41B performs the same process as the data transmission amount determining unit 41A. Specifically, the data transmission amount determining unit 41B increases the number of lanes set to the connected state as the amount of data transmitted increases or the sequentiality of data increases.

In the computer systems illustrated in FIGS. 3A and 3B, when the amount of data transmitted is greater than a predetermined value, the number of lanes set to the connected state increases. Therefore, it is possible to perform high-speed data communication. In the computer system illustrated in FIGS. 3A and 3B, when the amount of data transmitted is less than the predetermined value, the number of lanes set to the connected state is reduced. Therefore, it is possible to reduce power consumption.

In the computer systems illustrated in FIGS. 3A and 3B, when the sequentiality of data is greater than a predetermined value, the number of lanes set to the connected state increases. Therefore, it is possible to perform high-speed data communication. In the computer systems illustrated in FIGS. 3A and 3B, when the sequentiality of data is less than the predetermined value, the number of lanes set to the connected state is reduced. Therefore, it is possible to reduce power consumption. Next, a case in which the number of lanes set to the connected state increases as the amount of data transmitted increases will be described.

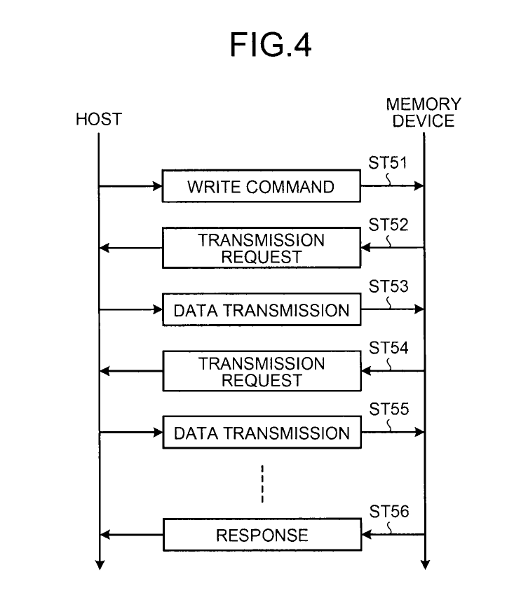

FIG. 4 is a diagram illustrating an example of a communication process when data is written between the host and the memory device. The host 2 issues a write command to the memory device 1 when starting a writing operation (ST51). The write command includes a logical address indicating a write position and information about the size of write data corresponding to the write command.

When receiving the write command, the memory device 1 determines the content of a request to transmit write data and transmits the request to the host 2 (ST52). The transmission request includes the size and offset address of a portion of the write data which is to be transmitted from the memory device 1 to the host 2. The offset address is used to specify the position of a portion of the data to be transmitted by the memory device 1.

When receiving the transmission request, the host 2 transmits the requested portion of the data to the memory device 1 (ST53). The memory device 1 writes the received portion of the data to the memory 11 and transmits a request to transmit another portion of the data (ST54). Then, when receiving the transmission request, the host 2 transmits the requested portion of the data to the memory device 1 (ST55).

This writing operation and the operation of requesting data transmission are sequentially performed until all of the write data is written to the memory 11. The memory device 1 transmits a response corresponding to whether the writing of all of the write data succeeds or fails to the host 2 (ST56). As such, when data is written to the memory device 1, the memory device 1 determines a portion of the write data (the size of data) and transmits a transmission request to the host 2.

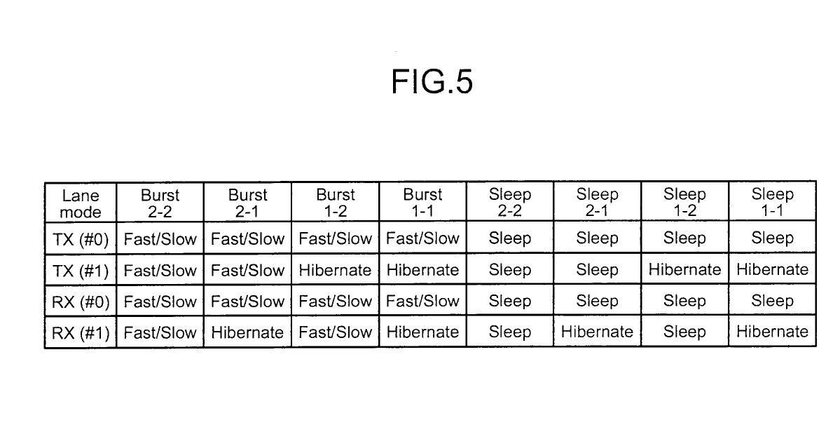

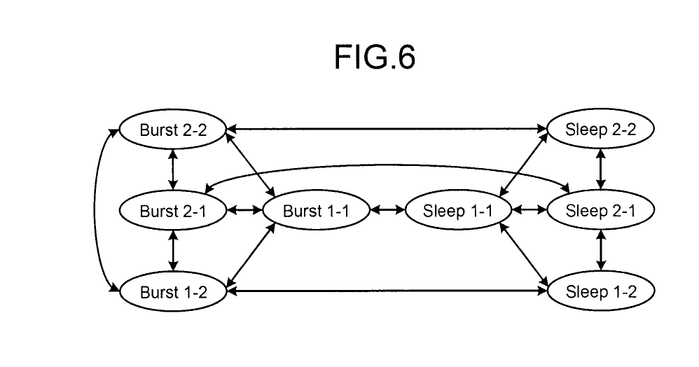

Next, a change in the mode of each of the lanes L0 to L3 (power state of M-PHY) will be described. FIG. 5 is a diagram illustrating an example of the power state set to the lanes and FIG. 6 is a diagram illustrating an example of the change in the mode of the lanes. The power state of the lanes L0 to L3 changes to the same state in the memory device 1 and the host 2. Therefore, a change in the mode of the memory device 1 will be described. In FIG. 6, Hibernate is not illustrated.

The port name described on the left end of FIG. 5 is the name of the transceiver port or the receiver port provided in the host 2. Specifically, TX(#0) is the transceiver port H-TX-0 and TX(#1) is the transceiver port H-TX-1. In addition, RX(#0) is the receiver port H-RX-0 and RX(#1) is the receiver port H-RX-1. In other words, the receiver port and the transceiver port provided in the memory device 1 form a pair therewith and the set states of the lanes L0 to L3 are changed at the same time.

Among the set states (the power states of M-PHY) of the lanes L0 to L3, the lane is in a Fast/Slow state when high-speed communication is performed. In addition, the lane is in a Sleep state when the state changes from the Fast/Slow state to a Hibernate state. In the Hibernate state, power consumption is reduced when data transmission is not performed.

For example, in a Burst 2-2 mode, two transceiver ports are in the Fast/Slow state and two receiver ports are in the Fast/Slow state. In a Burst 2-1 mode, two transceiver ports are in the Fast/Slow state, one receiver port is in the Fast/Slow state, and the other receiver port is in the Hibernate state. In a Burst 1-2 mode, two receiver ports are in the Fast/Slow state, one transceiver port is in the Fast/Slow state, and the other transceiver port is in the Hibernate state. In a Burst 1-1 mode, one transceiver port is in the Fast/Slow state, the other transceiver port is in the Hibernate state, one receiver port is in the Fast/Slow state, and the other receiver port is in the Hibernate state.

In a Sleep 2-2 mode, two transceiver ports are in the Sleep state and two receiver ports are in the Sleep state. In a Sleep 2-1 mode, two transceiver ports are in the Sleep state, one receiver port is in the Sleep state, and the other receiver port is in the Hibernate state. In a Sleep 2-1 mode, two receiver ports are in the Sleep state, one transceiver port is in the Sleep state, and the other transceiver port is in the Hibernate state. In a Sleep 1-1 mode, one transceiver port is in the Sleep state, the other transceiver port is in the Hibernate state, one receiver port is in the Sleep state, and the other receiver port is in the Hibernate state.

As illustrated in FIG. 6, the Burst 1-1 mode changes to the Burst 2-2 mode, the Burst 2-1 mode, the Burst 1-2 mode, or the Sleep 1-1 mode. The Burst 2-2 mode changes to the Burst 1-1 mode, the Burst 2-1 mode, the Burst 1-2 mode, or the Sleep 2-2 mode. The Burst 2-1 mode changes to the Burst 1-1 mode, the Burst 2-2 mode, the Burst 1-2 mode, or the Sleep 2-1 mode. The Burst 1-2 mode changes to the Burst 1-1 mode, the Burst 2-2 mode, the Burst 2-1 mode, or the Sleep 1-2 mode.

The Sleep 1-1 mode changes to the Sleep 2-2 mode, the Sleep 2-1 mode, the Sleep 1-2 mode, or the Burst 1-1 mode. The Sleep 2-2 mode changes to the Sleep 1-1 mode, the Sleep 2-1 mode, the Sleep 1-2 mode, or the Burst 2-2 mode. The Sleep 2-1 mode changes to the Sleep 1-1 mode, the Sleep 2-2 mode, the Sleep 1-2 mode, or the Burst 2-1 mode. The Sleep 1-2 mode changes to the Sleep 1-1 mode, the Sleep 2-2 mode, the Sleep 2-1 mode, or the Burst 1-2 mode.

The mode of the computer system according to this embodiment changes in the order of, for example, the Burst 2-1 mode (Burst 1-2 mode), the Burst 1-1 mode, the Sleep 1-1 mode, or the Hibernate mode or the reverse order thereof. In addition, the mode of the computer system may change in the order of, for example, the Burst 2-2 mode, the Burst 1-1 mode, the Sleep 1-1 mode, and the Hibernate mode or the reverse order thereof.

In this embodiment, the memory device 1 and the host 2 performs the change of the mode illustrated in FIG. 5 or FIG. 6, on the basis of the amount of data transmitted. The computer system performs communication in the connection mode using only one lane in the normal state and changing to the connection mode using two lanes when high-speed communication is needed, for example, when data is sequentially read. For example, the computer system changes to the Burst 1-1 mode in the normal state and changes to the Burst 2-2 mode when high-speed data communication is performed. Each of the lanes L0 to L3 may change to states other than the above-mentioned states.

Next, the procedure of a process of changing the connection state of the lanes L0 to L3 (mode change) will be described. Hereinafter, a process when the memory device 1 determines to change the mode and a process when the host 2 determines to change the mode will be described. When the memory device 1 determines to change the mode, the memory device 1A and the host 2A are used as the computer system. When the host 2 determines to change the mode, the memory device 1B and the host 2B are used as the computer system.

In this embodiment, the computer system initializes the mode (lane settings) when starting data communication, determines whether to change the mode before starting data communication, and changes the mode, if necessary. Then, after data communication is completed, the computer system returns the mode to the initial state. As such, the computer system according to this embodiment dynamically changes the connection state of the lanes L0 to L3, if necessary, whenever data communication instructed by one transmission command is performed. In this case, the computer system according to this embodiment changes the mode while performing a communication process, without changing to a special state for a mode change.

The computer system may determine whether to change the mode on the basis of the amount of data transmitted or the sequentiality of data which is indicated by a number of transmission commands transmitted from the host 2A at a predetermined time. In this case, the computer system determines whether to change the mode whenever one transmission command is transmitted. For example, in some cases, before data communication indicated by one transmission command is completed, the next transmission command is transmitted from the host 2A to the memory device 1A. In other words, in some cases, a number of transmission commands are sequentially transmitted from the host 2A to the memory device 1A. In this case, when the total amount of data transmitted is large, high-speed communication is needed, even though high-speed communication is not needed in data communication indicated by one transmission command. Therefore, the computer system may dynamically change the connection state of the lanes L0 to L3 on the basis of the total amount of data transmitted whenever one transmission command is transmitted.

### (1) Determination of Mode Change by Memory Device 1A

### Example 1-1

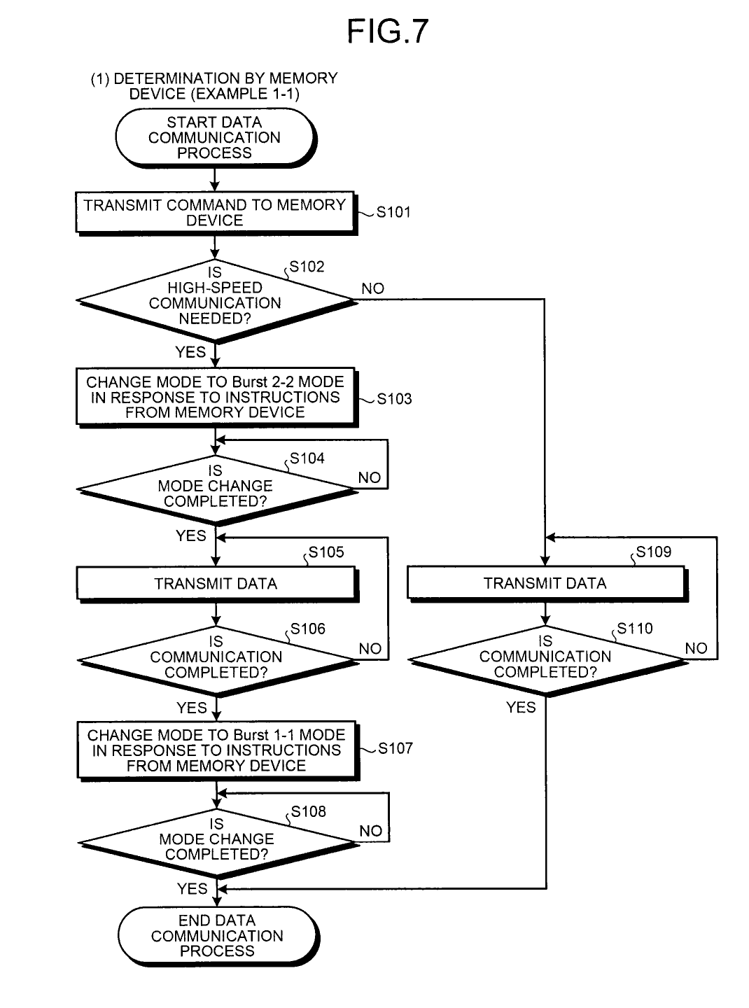

FIG. 7 is a flowchart illustrating the procedure of a mode change process when the mode is changed on the basis of the determination of the memory device and is changed to the initial mode after data communication is completed in the changed mode.

The host 2A transmits a data transmission command (a write command or a read command) 40 to the memory device 1A (Step S101). The transmission command 40 is transmitted to the memory controller 12A of the memory device 1A. The data transmission amount determining unit 41A determines whether high-speed communication is needed in data transmission in response to the transmission command (Step S102).

Specifically, the data transmission amount determining unit 41A determines the amount of data transmitted on the basis of the transmission command 40 and determines whether high-speed communication is needed on the basis of the determination result. When it is determined that high-speed communication is needed, the data transmission amount determining unit 41A determines one of the lanes L0 to L3 which is to be set to the connected state. In other words, the data transmission amount determining unit 41A determines the mode to be changed, on the basis of the determination result.

For example, when the amount of data transmitted is equal to or greater than a predetermined value, the data transmission amount determining unit 41A determines to change the mode to the Burst 2-2 mode. When the transmission command 40 is a read command and the amount of data transmitted is equal to or greater than the predetermined value, the data transmission amount determining unit 41A may change the mode to the Burst 1-2 mode. When the transmission command 40 is a write command and the amount of data transmitted is equal to or greater than the predetermined value, the data transmission amount determining unit 41A may change the mode to the Burst 2-1 mode. As such, when data communication is performed to read data, the data transmission amount determining unit 41A may increase the number of connections of the lanes used to read data. When data communication is performed to write data, the data transmission amount determining unit 41A may increase the number of connections of the lanes used to write data.

The data transmission amount determining unit 41A transmits the determined mode (lane settings) to the lane management unit 15A and the lane management unit 25A. Then, the lane management unit 15A changes the memory device 1A to the Burst 2-2 mode and the lane management unit 25A changes the host 2A to the Burst 2-2 mode.

As such, in the computer system, when the amount of data transmitted is equal to or greater than a predetermined value, it is determined that high-speed communication is needed. When it is determined that high-speed communication is needed (Yes in Step S102), the mode is changed to the Burst 2-2 mode in response to instructions from the memory device 1A (Step S103).

The lane management unit 15A of the memory device 1A and the lane management unit 25A of the host 2A each check whether the change of the mode has been completed (Step S104). When the change of the mode has not been completed (No in Step S104), the lane management units 15A and 25A each repeat the process of checking whether the change of the mode has been completed until the change of the mode is completed (Step S104).

When the change of the mode has been completed (Yes in Step S104), the memory controller 12A of the memory device 1A and the host controller 23 of the host 2A start data transmission (Step S105). When the transmission command is a write command, the memory controller 12A transmits a transmission request to the host controller 23. In this way, data transmission starts. On the other hand, when the transmission command is a read command, the memory controller 12A starts to transmit data to the host controller 23.

Then, the data transmission amount determining unit 41A checks whether a series of communication processes (data transmission) indicated by one transmission command has been completed (Step S106). When communication has not been completed (No in Step S106), data transmission is sequentially performed (Step S105). Then, the process of checking whether communication has been completed is repeated until communication is completed.

When communication has been completed (Yes in Step S106), the data transmission amount determining unit 41A transmits an instruction to change the mode to the initial mode (the mode when high-speed communication is not needed) to the lane management unit 15A and the lane management unit 25A. Specifically, the data transmission amount determining unit 41A transmits an instruction to change the mode to the Burst 1-1 mode to the lane management unit 15A and the lane management unit 25A. Then, the lane management unit 15A changes the memory device 1A to the Burst 1-1 mode and the lane management unit 25A changes the host 2A to the Burst 1-1 mode.

As such, after high-speed communication is completed in the Burst 2-2 mode, the mode is changed to the Burst 1-1 mode in response to instructions from the memory device 1A (Step S107). The lane management units 15A and 25A each check whether the change of the mode has been completed (Step S108). When the change of the mode has not been completed (No in Step S108), the lane management units 15A and 25A each repeat the process of checking whether the change of the mode has been completed until the change of the mode is completed (Step S108). When the change of the mode has been completed (Yes in Step S108), data communication in the computer system is completed.

When the data transmission amount determining unit 41A receives the transmission command transmitted from the host 2A and determines that high-speed communication is not needed in data transmission in response to the transmission command (No in Step S102), the memory device 1A and the host 2A start data transmission without changing the mode (Step S109). For example, when the amount of data transmitted is less than a predetermined value, the data transmission amount determining unit 41A determines that high-speed communication is not needed. When the transmission command is a write command, the memory controller 12A transmits a transmission request to the host controller 23. Then, data transmission starts. On the other hand, when the transmission command is a read command, the memory controller 12A starts to transmit data to the host controller 23.

Then, the data transmission amount determining unit 41A checks whether communication (data transmission) has been completed (Step S110). When communication has not been completed (No in Step S110), data transmission is sequentially performed (Step S109). Then, the process of checking whether communication has been completed is repeatedly performed until communication is completed. When communication has been completed (Yes in Step S110), data communication in computer system is completed.

### (2) Determination of Mode Change by Memory Device 1A

### Example 1-2

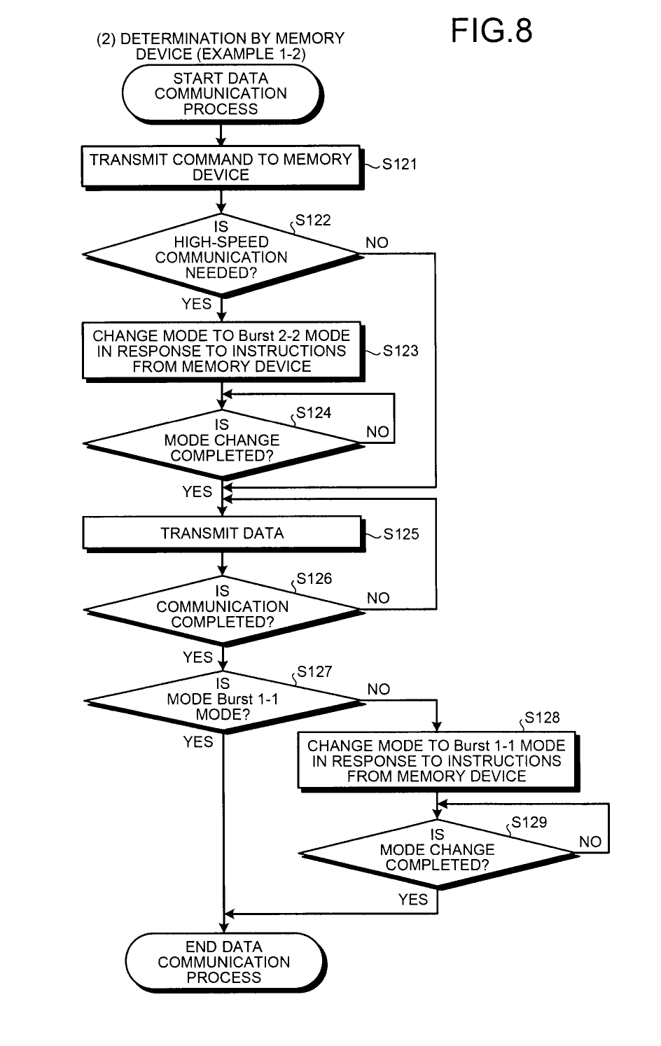

FIG. 8 is a flowchart illustrating the procedure of a mode change process when the mode is changed on the basis of the determination of the memory device and it is checked whether the mode is the initial mode after data communication is completed. In the process illustrated in FIG. 8, the description of the same steps as those in the process illustrated in FIG. 7 will not be repeated. For example, Steps S121 to S126 in FIG. 8 are the same as Steps S101 to S106 in FIG. 7.

The host 2A transmits the data transmission command 40 to the memory device 1A (Step S121). The data transmission amount determining unit 41A determines whether high-speed communication is needed in data transmission in response to the transmission command 40, on the basis of the transmission command 40 (Step S122). For example, when the amount of data transmitted is equal to or greater than a predetermined value, the data transmission amount determining unit 41A determines that high-speed communication is needed and determines to change the mode to the Burst 2-2 mode.

The data transmission amount determining unit 41A transmits the determined mode (lane settings) to the lane management unit 15A and the lane management unit 25A. Then, the lane management unit 15A changes the memory device 1A to the Burst 2-2 mode and the lane management unit 25A changes the host 2A to the Burst 2-2 mode.

As such, in the computer system, when the amount of data transmitted is equal to or greater than a predetermined value, it is determined that high-speed communication is needed and the mode is changed to the Burst 2-2 mode in response to instructions from the memory device 1A (Step S123).

The lane management units 15A and 25A each repeat the process of checking whether the change of the mode has been completed until the change of the mode is completed (Step S124). When the change of the mode has been completed (Yes in Step S124), the memory controller 12A and the host controller 23 start data transmission (Step S125).

When the data transmission amount determining unit 41A receives the transmission command transmitted from the host 2A and determines that high-speed communication is not needed in data transmission in response to the transmission command (No in Step S122), the memory device 1A and the host 2A start data transmission without changing the mode (Step S125).

Then, the data transmission amount determining unit 41A repeats the process of checking whether communication has been completed until communication is completed (Step S126). When communication has been completed (Yes in Step S126), the data transmission amount determining unit 41A checks whether the mode is the initial mode (Burst 1-1 mode) (Step S127).

When the mode is not the Burst 1-1 mode (No in Step S127), the data transmission amount determining unit 41A transmits an instruction to change the mode to the initial mode (the mode when high-speed communication is not needed) to the lane management unit 15A and the lane management unit 25A. Specifically, the data transmission amount determining unit 41A transmits an instruction to change the mode to the Burst 1-1 mode to the lane management unit 15A and the lane management unit 25A. Then, the lane management unit 15A changes the memory device 1A to the Burst 1-1 mode and the lane management unit 25A changes the host 2A to the Burst 1-1 mode.

As such, after high-speed communication has been completed, it is determined whether the mode is the Burst 1-1 mode, regardless of the currently set mode. In other words, it is determined whether the mode is the Burst 1-1 mode, regardless of whether the lane settings are changed. For example, it is determined whether the mode is the Burst 1-1 mode, regardless of whether the current mode is the Burst 2-2 mode or the Burst 1-1 mode. When the mode is not the Burst 1-1 mode, the mode is changed to the Burst 1-1 mode in response to instructions from the memory device 1A (Step S128).

Then, the lane management units 15A and 25A each check whether the change of the mode has been completed (Step S129). When the change of the mode has not been completed (No in Step S129), the lane management units 15A and 25A each repeat the process of checking whether the change of the mode has been completed until the change of the mode is completed (Step S129). When the change of the mode has been completed (Yes in Step S129), data communication in the computer system is completed.

When the mode after communication has been completed is the Burst 1-1 mode (Yes in Step S127), data communication in the computer system is completed, without changing the mode.

### (3) Determination of Mode Change by Host 2B

### Example 2-1

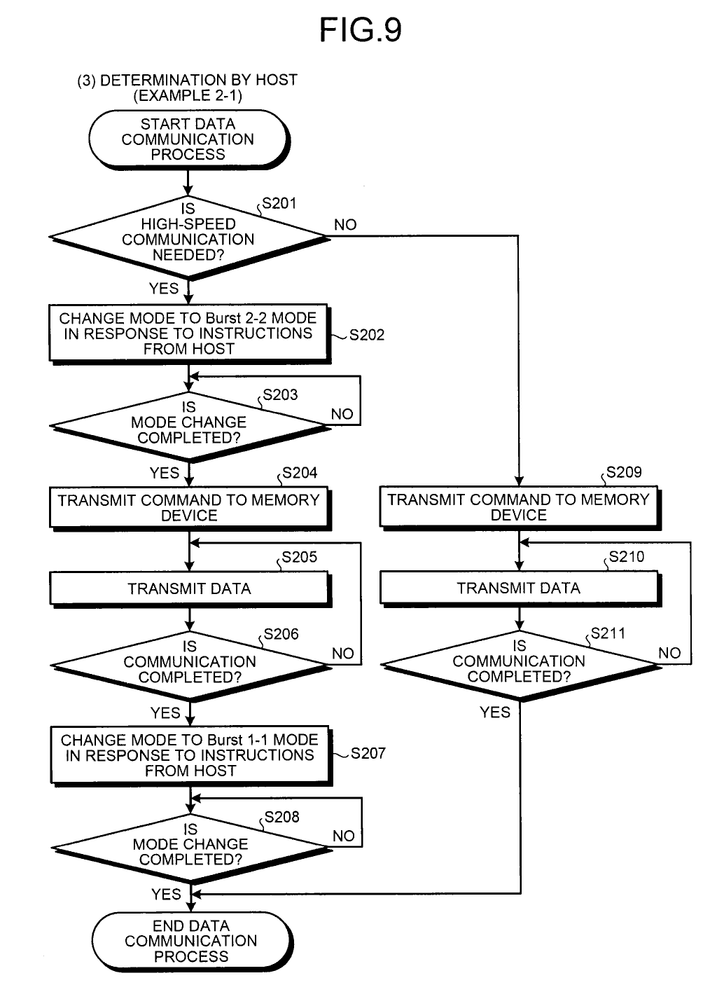

FIG. 9 is a flowchart illustrating the procedure of a mode change process when the mode is changed on the basis of the determination of the host and is changed to the initial mode after data communication is completed in the changed mode. In the process illustrated in FIG. 7, the mode is changed in response to instructions from the memory device 1A. However, in the process illustrated in FIG. 9, the mode is changed in response to instructions from the host 2B. In the process illustrated in FIG. 9, the description of the same steps as those in the process illustrated in FIG. 7 will not be repeated. For example, in FIG. 9, Steps S203, S205, S206, S208, S210, and S211 correspond to Steps S104, S105, S106, S108, S109, and S110 illustrated in FIG. 7.

When communication with the memory device 1B starts, the data transmission amount determining unit 41B of the host 2B determines whether high-speed communication is needed in data transmission in response to the transmission command 40 on the basis of the transmission command 40 (Step S201). For example, when the amount of data transmitted is equal to or greater than a predetermined value, the data transmission amount determining unit 41B determines that high-speed communication is needed and determines to change the mode to the Burst 2-2 mode.

The data transmission amount determining unit 41B transmits the determined mode (lane settings) to the lane management unit 15B and the lane management unit 25B. Then, the lane management unit 15B changes the memory device 1B to the Burst 2-2 mode and the lane management unit 25B changes the host 2B to the Burst 2-2 mode.

As such, in the computer system, when the amount of data transmitted is equal to or greater than a predetermined value, it is determined that high-speed communication is needed and the mode is changed to the Burst 2-2 mode in response to instructions from the host 2B (Step S202).

Then, when the change of the mode has been completed (Yes in Step S203), the host 2B transmits the data transmission command 40 to the memory device 1B (Step S204). Then, the host controller 23 and the memory controller 12B start data transmission (Step S205).

Then, when communication has been completed (Yes in Step S206), the data transmission amount determining unit 41B transmits an instruction to change the mode to the initial mode to the lane management unit 15B and the lane management unit 25B. Specifically, the data transmission amount determining unit 41B transmits an instruction to change the mode to the Burst 1-1 mode to the lane management unit 15B and the lane management unit 25B. Then, the lane management unit 15B changes the memory device 1B to the Burst 1-1 mode and the lane management unit 25B changes the host 2A to the Burst 1-1 mode.

As such, when high-speed communication in the Burst 2-2 mode is completed, the mode is changed to the Burst 1-1 mode in response to instructions from the host 2B (Step S207). Then, when the change of the mode has been completed (Yes in Step S208), data communication in the computer system is completed.

During the transmission of the transmission command from the host 2B to the memory device 1B, when the data transmission amount determining unit 41B determines that high-speed communication is not needed in data transmission in response to the transmission command (No in Step S201), the mode is not changed. For example, when the amount of data transmitted is less than a predetermined value, the data transmission amount determining unit 41B determines that high-speed communication is not needed.

In this case, the host 2B transmits the data transmission command 40 to the memory device 1B (Step S209). Then, the memory device 1B and the host 2B start data transmission without changing the mode (Step S210). Then, when communication has been completed (Yes in Step S211), data communication in the computer system is completed.

### (4) Determination of Mode Change by Host 2B

### Example 2-2

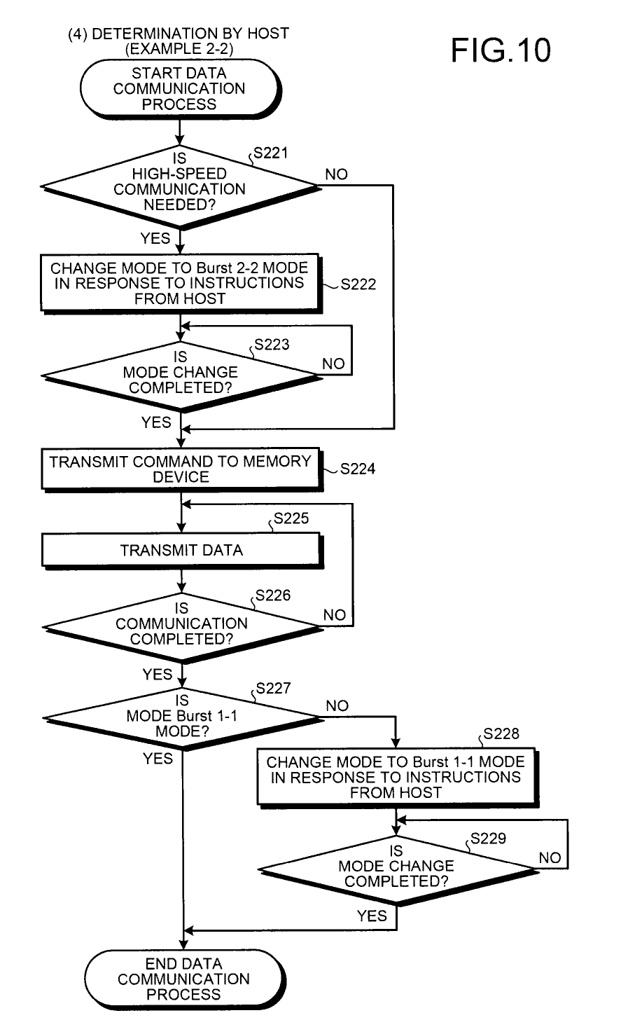

FIG. 10 is a flowchart illustrating the procedure of a mode change process when the mode is changed on the basis of the determination of the host and it is checked whether the mode is the initial mode after data communication is completed. In the process illustrated in FIG. 10, the description of the same steps as those in the process illustrated in FIG. 8 or FIG. 9 will not be repeated. For example, Steps S221 to S226 in FIG. 10 are substantially the same as Steps S201 to S206 in FIG. 9.

When communication with the memory device 1B starts, the data transmission amount determining unit 41B of the host 2B determines whether high-speed communication is needed in data transmission in response to the transmission command 40 on the basis of the transmission command 40 (Step S221).

When it is determined that high-speed communication is needed, the data transmission amount determining unit 41B determines to change the mode to the Burst 2-2 mode. The data transmission amount determining unit 41B transmits the determined mode to the lane management unit 15B and the lane management unit 25B. Then, the lane management unit 15B changes the memory device 1B to the Burst 2-2 mode and the lane management unit 25B changes the host 2B to the Burst 2-2 mode.

As such, in the computer system, when the amount of data transmitted is equal to or greater than a predetermined value, it is determined that high-speed communication is needed and the mode is changed to the Burst 2-2 mode in response to instructions from the host 2B (Step S222).

When the change of the mode has been completed (Yes in Step S223), the host 2B transmits the data transmission command 40 to the memory device 1B (Step S224). Then, the host controller 23 and the memory controller 12B start data transmission (Step S225).

Then, when communication has been completed (Yes in Step S226), the data transmission amount determining unit 41B checks whether the mode is the initial mode (Burst 1-1 mode) (Step S227).

When the mode is not the Burst 1-1 mode (No in Step S227), the data transmission amount determining unit 41B transmits an instruction to change the mode to the Burst 1-1 mode to the lane management unit 15B and the lane management unit 25B. Then, the lane management unit 15B changes the memory device 1B to the Burst 1-1 mode and the lane management unit 25B changes the host 2B to the Burst 1-1 mode.

As such, after high-speed communication is completed, it is determined whether the mode is the Burst 1-1 mode regardless of the currently set mode. When the mode is not the Burst 1-1 mode, the mode is changed to the Burst 1-1 mode in response to instructions from the host 2B (Step S228). Then, when the change of the mode has been completed (Yes in Step S229), data communication in the computer system is completed.

When the mode is the Burst 1-1 mode after communication is completed (Yes in Step S227), data communication in the computer system is completed, without changing the mode.

As such, according to the first embodiment, the host 2 and the memory device 1 are connected to each other by only one lane in the normal mode and are connected to each other by two or more lanes when high-speed communication is needed, for example, when data is sequentially read. Therefore, it is possible to perform high-speed data communication and reduce current consumption.

### Second Embodiment

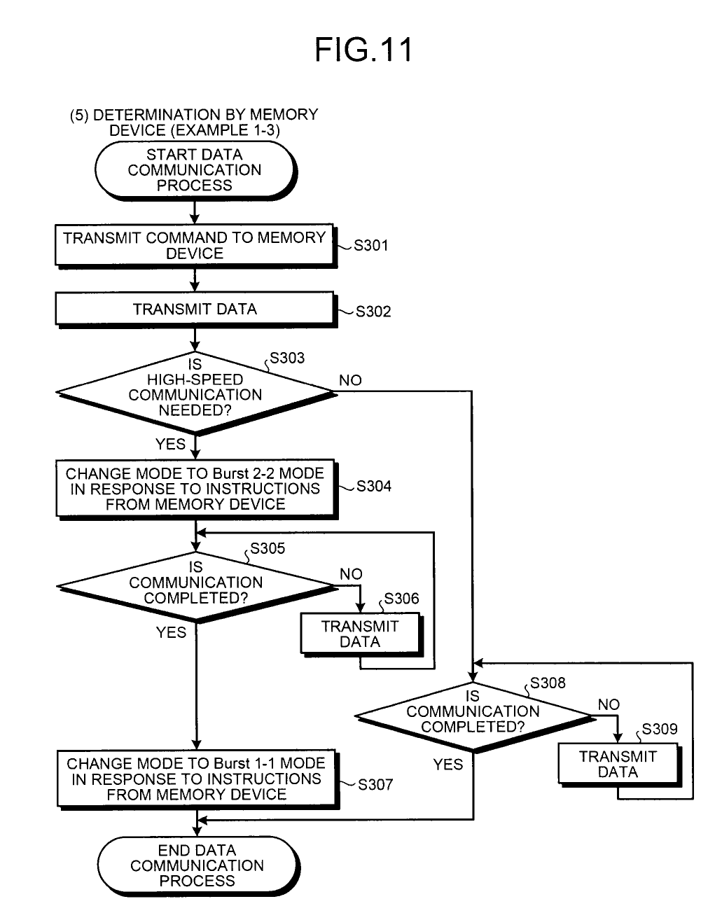

Next, a second embodiment will be described with reference to FIGS. 11 to 15B. In the second embodiment, a memory device and a host are connected to each other by only one lane in the normal mode. When high-speed communication is needed, for example, when data is sequentially read, data transmission starts using one lane. During a series of communication processes instructed by one transmission command, the memory device and the host are connected to each other by two or more lanes, if necessary.

### (5) Determination of Mode Change by Memory Device 1A

### Example 1-3

FIG. 11 is a flowchart illustrating the procedure of a mode change process when the mode is changed during communication on the basis of the determination of the memory device and is changed to the initial mode after data communication is completed in the changed mode. In the process illustrated in FIG. 11, the description of the same steps as those in the process illustrated in FIG. 7 will not be repeated.

A host 2A transmits a data transmission command 40 to the memory device 1A (Step S301). Then, a memory controller 12A of the memory device 1A and a host controller 23 of the host 2A start data transmission (Step S302).

Then, a data transmission amount determining unit 41A of the memory controller 12A determines whether high-speed communication is needed in data transmission in response to the transmission command, on the basis of the transmission command 40 (Step S303).

When it is determined that high-speed communication is needed (Yes in Step S303), the data transmission amount determining unit 41A determines to change the mode to a Burst 2-2 mode. The data transmission amount determining unit 41A transmits the determined mode to a lane management unit 15A and a lane management unit 25A. Then, the lane management unit 15A changes the memory device 1A to the Burst 2-2 mode and the lane management unit 25A changes the host 2A to the Burst 2-2 mode.

As such, in the computer system, when the amount of data transmitted is equal to or greater than a predetermined value, it is determined that high-speed communication is needed and the mode is changed to the Burst 2-2 mode in response to instructions from the memory device 1A (Step S304).

Then, the data transmission amount determining unit 41A determines whether communication has been completed (Step S305). When communication has not been completed (No in Step S305), data is sequentially transmitted (Step S306). In the computer system, the process of checking whether communication has been completed and the data transmission process are repeatedly performed until communication is completed.

When communication has been completed (Yes in Step S305), the data transmission amount determining unit 41A transmits an instruction to change the mode to a Burst 1-1 mode to the lane management unit 15A and the lane management unit 25A. Then, the lane management unit 15A changes the memory device 1A to the Burst 1-1 mode and the lane management unit 25A changes the host 2A to the Burst 1-1 mode. As such, after high-speed communication in the Burst 2-2 mode is completed, the mode is changed to the Burst 1-1 mode in response to instructions from the memory device 1A (Step S307). Then, when the change of the mode has been completed, data communication in the computer system is completed.

When it is determined by the data transmission amount determining unit 41A that high-speed communication is not needed in data transmission in response to the transmission command (No in Step S303), the data transmission amount determining unit 41A checks whether communication has been completed (Step S308). When communication has not been completed (No in Step S308), data is sequentially transmitted (Step S309). In the computer system, the process of checking whether communication has been completed and the data transmission process are repeatedly performed until communication is completed. When communication has been completed (Yes in Step S308), data communication in the computer system is completed.

### (6) Determination of Mode Change by Memory Device 1A

### Example 1-4

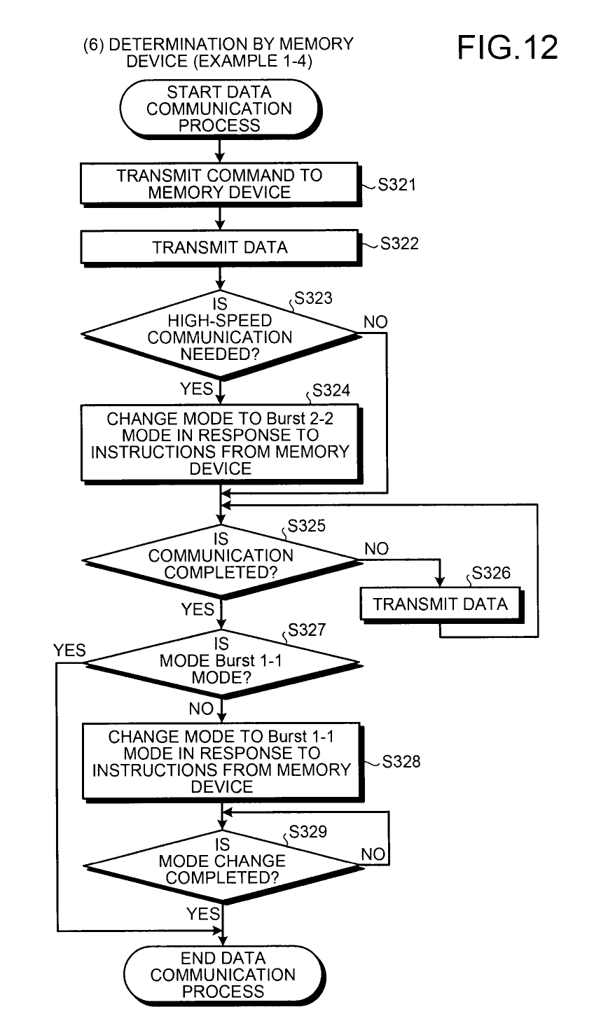

FIG. 12 is a flowchart illustrating the procedure of a mode change process when the mode is changed during communication on the basis of the determination of the memory device and it is checked whether the mode is the initial mode after data communication is completed. In the process illustrated in FIG. 12, the description of the same steps as those in the process illustrated in FIG. 8 or FIG. 11 will not be repeated. For example, Steps S321 to S326 illustrated in FIG. 12 are substantially the same as Steps S301 to S306 illustrated in FIG. 11.

The host 2A transmits the data transmission command 40 to the memory device 1A (Step S321). Then, the memory controller 12A of the memory device 1A and the host controller 23 of the host 2A start data transmission (Step S322).

Then, the data transmission amount determining unit 41A of the memory controller 12A determines whether high-speed communication is needed in data transmission in response to the transmission command, on the basis of the transmission command 40 (Step S323).

When it is determined that high-speed communication is needed (Yes in Step S323), the data transmission amount determining unit 41A determines to change the mode to the Burst 2-2 mode. The data transmission amount determining unit 41A transmits the determined mode to the lane management unit 15A and the lane management unit 25A. Then, the lane management unit 15A changes the memory device 1A to the Burst 2-2 mode and the lane management unit 25A changes the host 2A to the Burst 2-2 mode.

As such, in the computer system, when the amount of data transmitted is equal to or greater than a predetermined value, it is determined that high-speed communication is needed and the mode is changed to the Burst 2-2 mode in response to instructions from the memory device 1A (Step S324).

When communication has not been completed (No in Step S325), data is sequentially transmitted (Step S326). In the computer system, the process of checking whether communication has been completed and the data transmission process are repeatedly performed until communication is completed.

When communication has been completed (Yes in Step S325), the data transmission amount determining unit 41A checks whether the mode is the Burst 1-1 mode (Step S327). When the mode is not the Burst 1-1 mode (No in Step S327), the data transmission amount determining unit 41A transmits an instruction to change the mode to the Burst 1-1 mode to the lane management unit 15A and the lane management unit 25A. Then, the lane management unit 15A changes the memory device 1A to the Burst 1-1 mode and the lane management unit 25A changes the host 2A to the Burst 1-1 mode. As such, after high-speed communication is completed, it is determined whether the mode is the Burst 1-1 mode, regardless of the currently set mode (Step S328).

When the change of the mode has been completed (Yes in Step S329), data communication in the computer system is completed. When the mode is the Burst 1-1 mode after communication is completed (Yes in Step S327), data communication in the computer system is completed, without changing the mode.

### (7) Determination of Mode Change by Host 2B

### Example 2-3

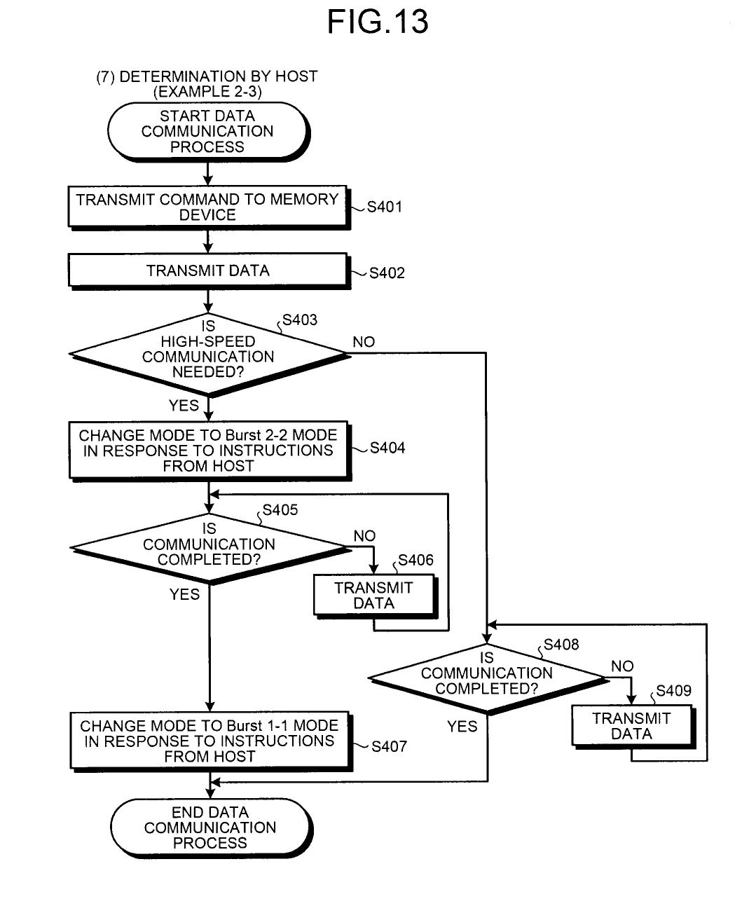

FIG. 13 is a flowchart illustrating the procedure of a mode change process when the mode is changed during communication on the basis of the determination of the host and is changed to the initial mode after data communication is completed in the changed mode. In the process illustrated in FIG. 13, the description of the same steps as those in the process illustrated in FIG. 9 or FIG. 11 will not be repeated.

The host 2B transmits a data transmission command 40 to a memory device 1B (Step S401). Then, a memory controller 12B and a host controller 23 start data transmission (Step S402).

Then, a data transmission amount determining unit 41B determines whether high-speed communication is needed in data transmission in response to the transmission command, on the basis of the transmission command 40 (Step S403).

When it is determined that high-speed communication is needed (Yes in Step S403), the data transmission amount determining unit 41B determines to change the mode to the Burst 2-2 mode. The data transmission amount determining unit 41B transmits the determined mode to a lane management unit 15B and a lane management unit 25B. Then, the lane management unit 15B changes the memory device 1B to the Burst 2-2 mode and the lane management unit 25B changes the host 2B to the Burst 2-2 mode.

As such, in the computer system, when the amount of data transmitted is equal to or greater than a predetermined value, it is determined that high-speed communication is needed and the mode is changed to the Burst 2-2 mode in response to instructions from the host 2B (Step S404).

Then, the data transmission amount determining unit 41B checks whether communication has been completed (Step S405). When communication has not been completed (No in Step S405), data is sequentially transmitted (Step S406). In the computer system, the process of checking whether communication has been completed and the data transmission process are repeatedly performed until communication is completed.

When communication has been completed (Yes in Step S405), the data transmission amount determining unit 41B transmits an instruction to change the mode to the Burst 1-1 mode to the lane management unit 15B and the lane management unit 25B. Then, the lane management unit 15B changes the memory device 1B to the Burst 1-1 mode and the lane management unit 25B changes the host 2B to the Burst 1-1 mode. As such, after high-speed communication in the Burst 2-2 mode is completed, the mode is changed to the Burst 1-1 mode in response to instructions from the host 2B (Step S407). Then, when the change of the mode has been completed, data communication in the computer system is completed.

In the computer system, when the data transmission amount determining unit 41B determines that high-speed communication is not needed in data transmission in response to the transmission command (No in Step S403), the process of checking whether communication has been completed and the data transmission process are repeatedly performed until communication is completed (Steps S408 and S409). When communication has been completed (Yes in Step S408), data communication in the computer system is completed.

### (8) Determination of Mode Change by Host 2B

### Example 2-4

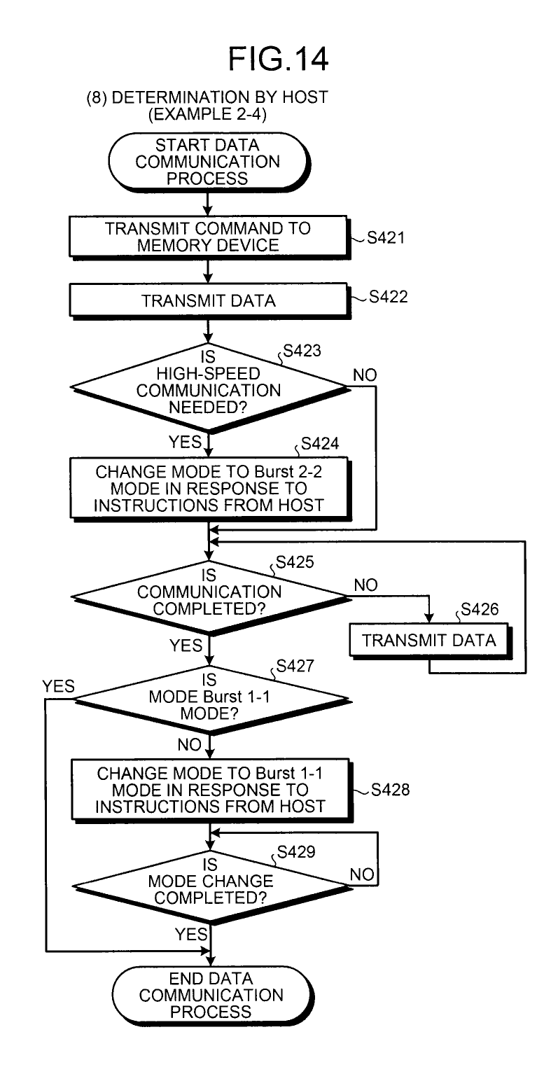

FIG. 14 is a flowchart illustrating the procedure of a mode change process when the mode is changed during communication on the basis of the determination of the host and it is checked whether the mode is the initial mode after data communication is completed. In the process illustrated in FIG. 14, the description of the same steps as those in the process illustrated in, for example, FIG. 10, FIG. 12, or FIG. 13 will not be repeated.

The host 2B transmits the data transmission command 40 to the memory device 1B (Step S421). Then, the memory controller 12B of the memory device 1B and the host controller 23 of the host 2B start data transmission (Step S422).

Then, the data transmission amount determining unit 41B determines whether high-speed communication is needed in data transmission in response to the transmission command, on the basis of the transmission command 40 (Step S423).

When it is determined that high-speed communication is needed (Yes in Step S423), the data transmission amount determining unit 41B determines to change the mode to the Burst 2-2 mode. The data transmission amount determining unit 41B transmits the determined mode to the lane management unit 15B and the lane management unit 25B. Then, the lane management unit 15B changes the memory device 1B to the Burst 2-2 mode and the lane management unit 25B changes the host 2B to the Burst 2-2 mode.

As such, in the computer system, when the amount of data transmitted is equal to or greater than a predetermined value, it is determined that high-speed communication is needed and the mode is changed to the Burst 2-2 mode in response to instructions from the memory device 1B (Step S424).

Then, the data transmission amount determining unit 41B checks whether communication has been completed. Even when it is determined that high-speed communication is not needed (No in Step S423), the data transmission amount determining unit 41B checks whether communication has been completed (Step S425).

When communication has not been completed (No in Step S425), data is sequentially transmitted (Step S426). In the computer system, the process of checking whether communication has been completed and the data transmission process are repeatedly performed until communication is completed.

When communication has been completed (Yes in Step S425), the data transmission amount determining unit 41B checks whether the mode is the Burst 1-1 mode (Step S427). When the mode is not the Burst 1-1 mode (No in Step S427), the data transmission amount determining unit 41B transmits an instruction to change the mode to the Burst 1-1 mode to the lane management unit 15B and the lane management unit 25B. Then, the lane management unit 15B changes the memory device 1B to the Burst 1-1 mode and the lane management unit 25B changes the host 2B to the Burst 1-1 mode. As such, after high-speed communication is completed, it is determined whether the mode is the Burst 1-1 mode, regardless of the currently set mode (Step S428).

Then, when the change of the mode has been completed (Yes in Step S429), data communication in the computer system is completed. When the mode is the Burst 1-1 mode after communication is completed (Yes in Step S427), data communication in the computer system is completed, without changing the mode.

In this embodiment, data can be transmitted while a multiple lanes are being connected and the computer system does not wait for the completion of the connection of the lanes. It is difficult to transmit data while the setting of the connection lane is changed, depending on computer systems. In this case, the computer system checks whether data transmission is cut off before lane settings are changed and waits until a change in the number of lanes is completed.

Specifically, the lane management unit 15B or the lane management unit 25B changes the connection state of each of the lanes L0 to L3 at the time when data communication is cut off and resumes data communication after the connection state of each of the lanes L0 to L3 is changed (completed).

As such, according to the second embodiment, the host 2 and the memory device 1 are connected to each other by only one lane in the normal mode and data transmission starts using one lane even when high-speed communication is needed. However, two or more lanes are used to connect the host 2 and the memory device 1 during communication, if necessary. Therefore, it is possible to perform high-speed data communication and reduce current consumption. In addition, when high-speed data communication is performed, the computer system does not wait until the mode is changed. Therefore, it is possible to reduce the time required until data communication starts.

In the first and second embodiments, the host 2 and the memory device 1 are connected to each other by two upstream lanes and two downstream lanes. However, the host 2 and the memory device 1 may be connected to each other by three or more upstream lanes and/or three or more downstream lanes. In addition, the host 2 and the memory device 1 may be connected to each other by one upstream lane or one downstream lane. The numbers of upstream and downstream lanes connecting the host 2 and the memory device 1 may be asymmetric.

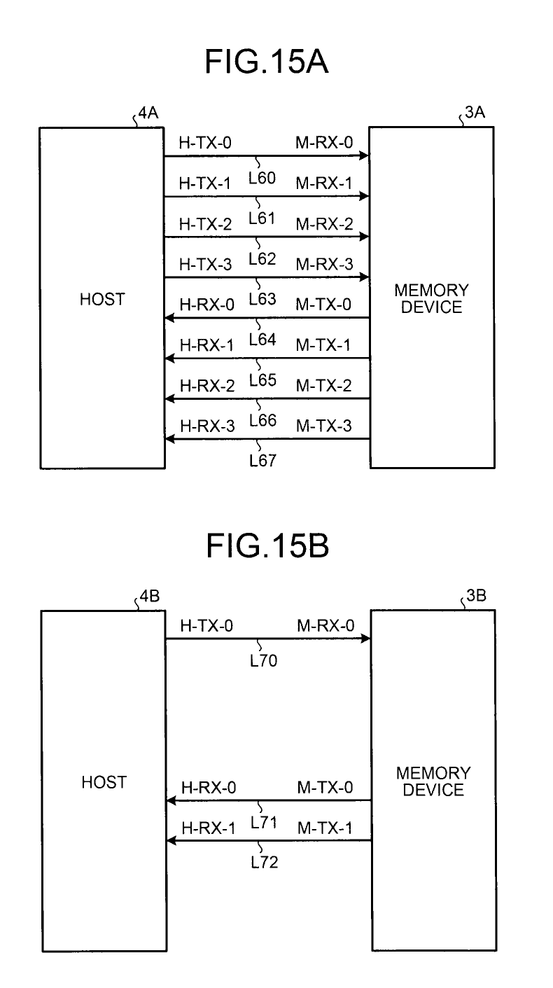

FIG. 15A is a diagram illustrating the structure of a computer system in which the host and the memory device are connected to each other by four upstream lanes and four downstream lanes. A host 4A includes transceiver ports H-TX-0 to H-TX-3 and receiver ports H-RX-0 to H-RX-3. A memory device 3A includes receiver ports M-RX-0 to M-RX-3 and transceiver ports M-TX-0 to M-TX-3.

The transceiver ports H-TX-0 to H-TX-3 are connected one to one to the receiver ports M-RX-0 to M-RX-3 to form lanes L60 to L63. In addition, the transceiver ports M-TX-0 to M-TX-3 are connected one to one to the receiver ports H-RX-0 to H-RX-3 to form lanes L64 to L67.

For example, the transceiver port H-TX-0 and the receiver port M-RX-0 are connected to each other to form the lane L60 and the transceiver port H-TX-1 and the receiver port M-RX-1 are connected to each other to form the lane L61. In addition, the transceiver port M-TX-2 and the receiver port H-RX-2 are connected to each other to form the lane L62 and the transceiver port M-TX-3 and the receiver port H-RX-3 are connected to form the lane L67.

For example, when three or more lanes may be set to upstream communication or downstream communication, the computer system sets the number of lanes which are used depending on the amount of data transmitted. For example, when the amount of data transmitted is greater than a first threshold value, the computer system uses two lanes. When the amount of data transmitted is greater than a threshold value of N-th (N is a natural number equal to or greater than 2), the computer system uses (N+1)-th lanes.

FIG. 15B is a diagram illustrating the structure of a computer system when the numbers of upstream and downstream lanes of a host and a memory device are asymmetric. A host 4B includes a transceiver port H-TX-0 and receiver ports H-RX-0 and H-RX-1. In addition, a memory device 3B includes a receiver port M-RX-0 and transceiver ports M-TX-0 and M-TX-1.

The transceiver port H-TX-0 and the receiver port M-RX-0 are connected to each other to form a lane L70. In addition, the transceiver ports M-TX-0 and M-TX-1 are connected one to one to the receiver ports H-RX-0 and H-RX-1 to form lanes L71 and L72.

In the computer system illustrated in FIG. 15B, the number of downstream lanes is one, as viewed from the host 4B, and the number of upstream lanes is two, as viewed from the host 4B. Therefore, the numbers of upstream and downstream lanes are asymmetric.

In the first and second embodiments, when a device which does not control the communication path starts communication while the connection of the communication path is being switched, a problem is likely to arise. Therefore, in the computer system, the lanes which are constantly connected may be defined as a method of using a multiple communication paths. In this case, communication (for example, command transmission) which is likely to start to transmit data while the connection of the communication path is being switched is performed using the lane which is constantly connected. Therefore, a multiple lanes which are connected if necessary are used only for high-speed data communication.

As such, according to the first and second embodiments, when high-speed communication is needed, the number of lanes used for data transmission increases. When high-speed communication is not needed, the number of lanes used for data transmission is reduced. Therefore, it is possible to perform high-speed data communication and reduce current consumption.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A memory device comprising:
a non-volatile storage device from which data is read and to which data is written in response to a request from a host device;
an interface that is connected to the host device by a multiple upstream lanes and/or a multiple downstream lanes and performs data communication in both directions with the host device; and
a memory controller that controls the non-volatile storage device and the interface,
wherein the memory controller includes a lane change unit that changes a connection state of each lane on the basis of lane settings which are used for communication with the host device and are determined on the basis of at least one of an amount of data transmitted and the sequentiality of data when the data is transmitted between the memory device and the host device.

2. The memory device according to claim 1,
wherein the memory controller further includes a data transmission determining unit that determines at least one of the amount of data transmitted and the sequentiality of the data on the basis of a data transmission command transmitted from the host device and determines the lane settings used for the communication with the host device on the basis of at least one of the amount of data transmitted and the sequentiality of the data, and
the lane change unit changes the connection state of the lanes on the basis of the lane settings determined by the data transmission determining unit.

3. The memory device according to claim 1,
wherein the lane change unit changes the connection state of the lanes on the basis of the lane settings transmitted from the host device.

4. The memory device according to claim 2,
wherein the data transmission determining unit sets the lane settings to an initial state before the data communication with the host device, and
the data transmission determining unit changes the lane settings such that the number of lanes is more than that in the initial state when the amount of data transmitted is greater than a predetermined value or the sequentiality of the data is greater than a predetermined value.

5. The memory device according to claim 2,
wherein, when the lane settings are changed such that the number of lanes is more than that in an initial state, the data transmission determining unit changes the lane settings to the initial state after the data communication is completed.

6. The memory device according to claim 2,
wherein the data transmission determining unit checks whether the lane settings are in the initial state after the data communication is completed, regardless of whether the lane settings are changed during the data communication, and
the data transmission determining unit changes the lane settings to the initial state when the lane settings are not in the initial state.

7. The memory device according to claim 2,
wherein the data transmission determining unit determines the lane settings before the data communication starts, and
the lane change unit changes the connection state of each lane before the data communication starts.

8. The memory device according to claim 2,
wherein the data transmission determining unit determines the lane settings after the data communication starts, and
the lane change unit changes the connection state of each lane during the data communication.

9. The memory device according to claim 8,
wherein the lane change unit changes the connection state of each lane at a time when the data communication is cut off and resumes the data communication after the connection state of each lane is changed.

10. The memory device according to claim 2,
wherein, when the data communication is performed to read the data, the data transmission determining unit increases the number of connections of the lanes used to read the data, thereby changing the lane settings.

11. The memory device according to claim 2,
wherein, when the data communication is performed to write the data, the data transmission determining unit increases the number of connections of the lanes used to write the data, thereby changing the lane settings.

12. The memory device according to claim 2,
wherein the data transmission determining unit determines a first lane which is constantly connected and a second lane which is changed the lane settings on the basis of at least one of the amount of data transmitted and the sequentiality of the data,
the data transmission command is received by the first lane, and
when the data communication is performed, the data transmission determining unit determines whether to set the second lane as a lane which is used for communication with the host device, on the basis of at least one of the amount of data transmitted and the sequentiality of the data.

13. The memory device according to claim 1,
wherein the memory device is a UFS device, and
the host device is a UFS host that supports the UFS device.

14. The memory device according to claim 13,
wherein, when the number of lanes used for the data communication is increased, the data transmission determining unit increases the number of lanes for setting a power state of M-PHY to a Fast/Slow state.

15. A computer system comprising:
a host device; and
a memory device that performs data communication in both directions with the host device,
wherein the memory device includes:
a non-volatile storage device from which data is read and to which data is written in response to a request from a host device;
a first interface that is connected to the host device by a multiple upstream lanes and/or a multiple downstream lanes and performs the data communication with the host device; and
a memory controller that controls the non-volatile storage device and the first interface,
the memory controller includes a first lane change unit that changes a connection state of each lane in the first interface, on the basis of lane settings which are used for communication with the host device and are determined on the basis of at least one of an amount of data transmitted and the sequentiality of data during the data transmission with the host device, and
the host device includes:
a second interface that is connected to the memory device by the multiple lanes and performs data communication with the memory device; and
a second lane change unit that changes the connection state of each lane in the second interface on the basis of the lane settings.

16. The computer system according to claim 15,
wherein the memory controller further includes a first data transmission determining unit that determines at least one of the amount of data transmitted and the sequentiality of the data on the basis of a data transmission command transmitted from the host device and determines the lane settings used for the communication with the host device on the basis of at least one of the amount of data transmitted and the sequentiality of the data, and
the first and second lane change units change the connection state of the lanes on the basis of the lane settings determined by the first data transmission determining unit.

17. The computer system according to claim 15,
wherein the host device further includes a second data transmission determining unit that determines at least one of the amount of data transmitted and the sequentiality of the data on the basis of a data transmission command transmitted to the memory device and determines the lane settings used for communication with the memory device on the basis of at least one of the amount of data transmitted and the sequentiality of the data, and
the first and second lane change units change the connection state of the lanes on the basis of the lane settings determined by the second data transmission determining unit.

18. The computer system according to claim 16,
wherein the first data transmission determining unit sets the lane settings to an initial state before the data communication with the host device, and
the data transmission determining unit changes the lane settings such that the number of lanes is more than that in the initial state when the amount of data transmitted is greater than a predetermined value or the sequentiality of the data is greater than a predetermined value.

19. The computer system according to claim 16,
wherein, when the lane settings are changed such that the number of lanes is more than that in the initial state, the first data transmission determining unit changes the lane settings to the initial state after the data communication is completed.

20. The computer system according to claim 16,
wherein the first data transmission determining unit checks whether the lane settings are in the initial state after the data communication is completed, regardless of whether the lane settings are changed during the data communication, and
the first data transmission determining unit changes the lane settings to the initial state when the lane settings are not in the initial state.
